(19) United States
(12) Patent Application Publication
(10) Pub. No.: US 2025/0389928 A1
(43) Pub. Date: Dec. 25, 2025

(54) FINE FOCUS ADJUSTMENT FOR LENS USING PRESSURE

(71) Applicant: Raytheon Company, Tewksbury, MA (US)

(72) Inventors: Gregory Paul Matthews, Plano, TX (US); Matthew Aaron Sinclair, Allen, TX (US); Robert B. Chipper, McKinney, TX (US); Randall W. Zywicki, McKinney, TX (US)

(21) Appl. No.: 18/747,962

(22) Filed: Jun. 19, 2024

(51) Int. Cl. G02B 7/04; G03B 17/12

(52) U.S. Cl. CPC G02B 7/04; G03B 17/12

(57) ABSTRACT

An apparatus includes a detector, a refractive system, and a hermetically-sealed container. The refractive system is configured to focus light on the detector. The hermetically-sealed container encompasses the detector and the refractive system and is configured to maintain an operational pressure in an internal volume of the container for focusing the refractive system at operating conditions.

### TECHNICAL FIELD

This disclosure relates generally to optical devices and processes. More specifically, this disclosure relates to fine focus adjustment for a lens using pressure.

### BACKGROUND

Higher-resolution imaging detectors often require fine detector positioning, which can be time-consuming and expensive. A focus mechanism is often added to compensate for lens and detector positioning, but this leads to additional complexity, cost, and failure mechanisms. The detectors are often shimmed or bonded into place as compensators. Shimming is often limited to 0.0005 inches and bonding is time consuming.

Focus may need to be adjusted for initial alignment, changes over temperature, changes over pressure, and object distance. This is often solved by adding focus mechanisms to translate along the optical axis, fold into the optical path, or adjust a powered surface. All of these methods introduce boresight error as a lens's focus is adjusted, shifting the line of sight for the system.

### SUMMARY

This disclosure relates to fine focus adjustment for a lens using pressure.

In a first embodiment, an apparatus includes a detector, a refractive system, and a hermetically-sealed container. The refractive system is configured to focus light on the detector. The hermetically-sealed container encompasses the detector and the refractive system and is configured to maintain an operational pressure in an internal volume of the container for focusing the refractive system at operating conditions.

Any single one or any combination of the following features may be used with the first embodiment. The operational pressure may not be an ambient pressure. The apparatus may further include a pressure control configured to adjust the operational pressure in the internal volume of the container. The pressure control may include an actuator configured to adjust a wall of the container in order to adjust the operational pressure of the internal volume. The pressure control may include an actuator configured to apply a force to a flexible surface of the container in order to adjust the operational pressure of the internal volume. The pressure control may include a compressor configured to adjust the operational pressure of the internal volume. The pressure control may include a valve configured to adjust the operational pressure of the internal volume. The refractive system may include an imager. The refractive system may include a relay imager. The sensor may be passive optically athermal or passive optomechanically athermal over operational temperatures.

In a second embodiment, a method includes encompassing a detector and a refractive system in a hermetically-sealed container. The method also includes maintaining an operational pressure in an internal volume of the container for focusing the refractive system at operating conditions.

Any single one or any combination of the following features may be used with the second embodiment. The operational pressure may not be an ambient pressure. The method may further include adjusting, using a pressure control, the operational pressure in the internal volume of the container. Adjusting the operational pressure using the pressure control may comprise adjusting, using an actuator, a wall of the container in order to adjust the operational pressure of the internal volume. Adjusting the operational pressure using the pressure control may comprise applying, using an actuator, a force to a flexible surface of the container in order to adjust the operational pressure of the internal volume. Adjusting the operational pressure using the pressure control may comprise adjusting, using a compressor, the operational pressure of the internal volume. Adjusting the operational pressure using the pressure control may comprise adjusting, using a valve, the operational pressure of the internal volume. The refractive system may include an imager. The refractive system may include a relay imager. The sensor may be passive optically athermal or passive optomechanically athermal over operational temperatures.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIGS. 1A and 1B illustrate an example finely-adjustable lens cell in accordance with this disclosure;

FIGS. 2A through 2F illustrate example refractive systems for use in a finely-adjustable lens cell in accordance with this disclosure;

FIG. 3 illustrates an example method for fine focus adjustment for a lens using pressure in accordance with this disclosure;

FIG. 4 illustrates an example calculation for lens adjustment using pressure in accordance with this disclosure; and

FIGS. 5A through 5L illustrate example results for fine focus adjustment for a lens using pressure in accordance with this disclosure.

### DETAILED DESCRIPTION

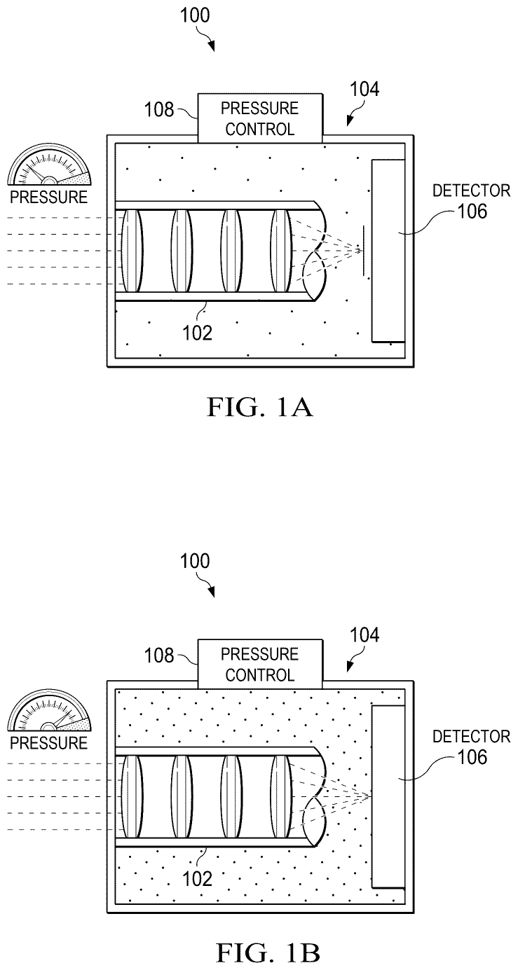

FIGS. 1A through 3, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As described above, fine adjustment of a lens can be time-consuming, expensive, and cause other issues like boresight errors. This disclosure provides various techniques for providing fine focus adjustment for a lens using pressure. Unlike epoxy or shimming a detector, pressurizing a lens cell to adjust focus can occur quickly. Also, the focus may be adjusted from infinity by changing the pressure with no lens motion, effectively maintaining boresight. Further, an athermal lens can be athermal over temperature (not pressure) and using pressure to adjust lens focus can compensate for unpressurized focal effects. In addition, maintenance of a pressure line can be external to an imaging unit, which makes servicing easier. These techniques may be useful in any number of applications, such as applications involving new detectors with small pixel pitch and fast lenses that require micron precision alignment to maximize detector performance.

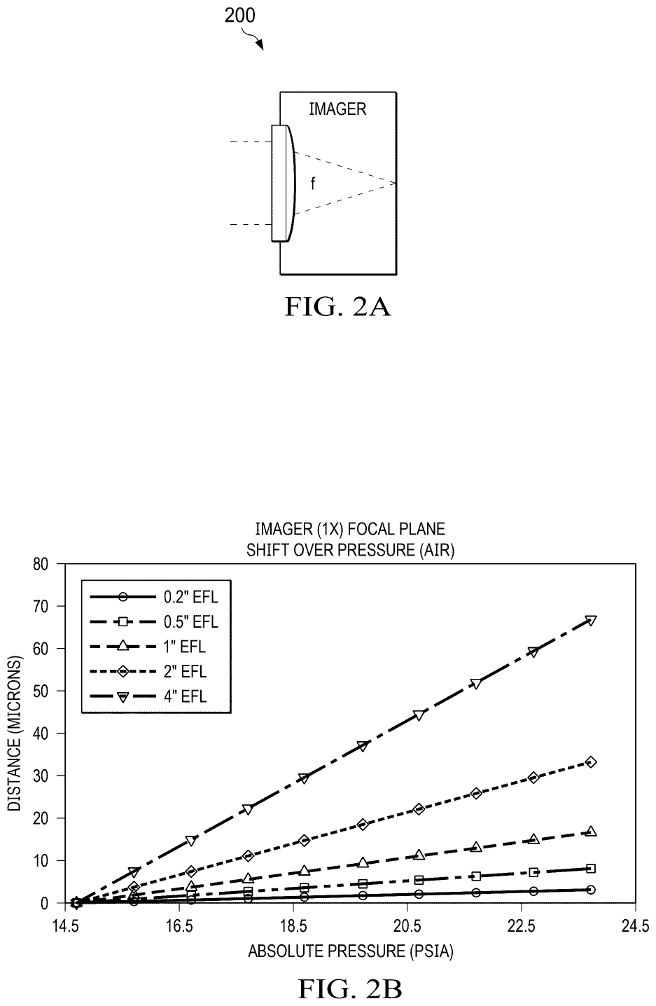

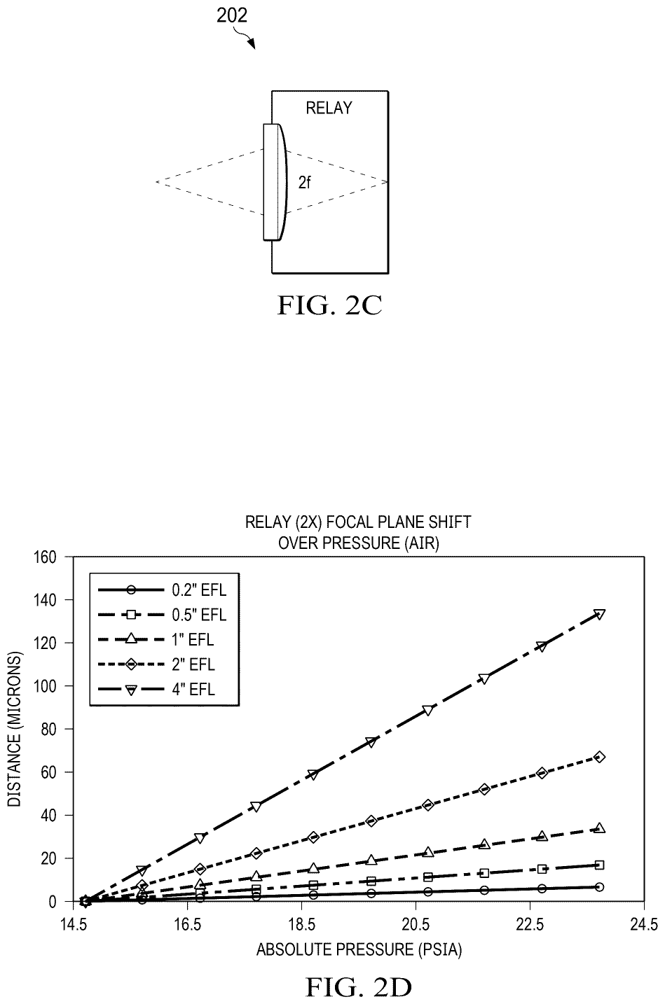

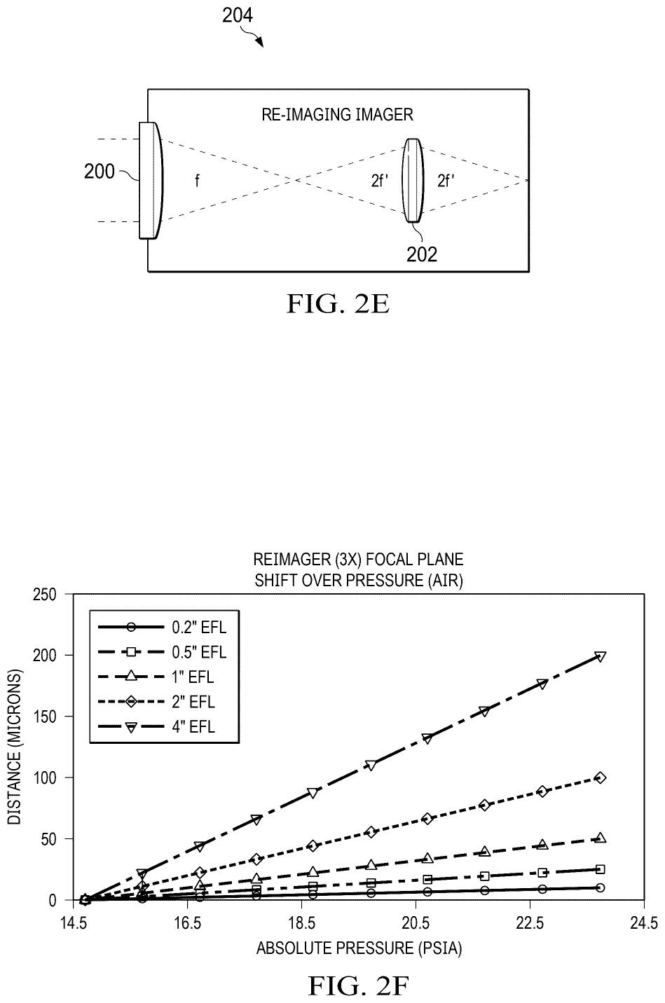

FIGS. 1A and 1B illustrate an example finely-adjustable lens cell 100 in accordance with this disclosure. FIGS. 2A through 2F illustrate example refractive systems 200-204 for use in a finely-adjustable lens cell in accordance with this disclosure.

As shown in FIGS. 1A and 1B, the lens cell 100 can be pressurized to make focus adjustments. The lens cell 100 includes a refractive system 102, a hermetically-sealed container 104, a detector 106, and a pressure control 108. The lens cell 100 can quickly and finely adjust focus of one or more lenses in the refractive system 102 using changes in pressure. The pressure can be adjusted to a specific operational level (a constant pressure) or can be adjustable based on operating conditions (a variable pressure). The lens cell 100 does not require epoxy or shimming of the detector 106, and the lens cell 100 may use one or more lenses that are athermal. In machine tool systems (MTS), the lens cell 100 could be used to have an imager compensate for unpressurized focal conditions. Using pressure on the lens cell 100 improves case of maintenance on pressure lines, such as pressure control 108, external to the lens cell 100.

The refractive system 102 can be formed in the lens cell 100 to receive light and focus the light on the detector 106. For example, the refractive system 102 may include one or more optical lenses. In this example, the refractive system 102 includes four lenses or other optical devices in series, although the refractive system 102 may have any suitable number(s) and type(s) of optical devices. Different types of refractive systems 102 can be implemented in the lens cell 100, including the example refractive system 200-204 shown in FIGS. 2A, 2C, and 2E. FIGS. 2B, 2D, and 2F show the effect of changing pressure on the respective refractive systems 200-204. For instance, the refractive system 102 can includes an imager 200, a relay imager 202, or a reimaging lens 204. In some embodiments, the imager 200 can have an infinity focus, the relay imager 202 can have a 1× magnification, and/or the reimaging lens 204 can have a 1× relay with an infinity focus. However, this is just one example of how the refractive system 102 may be implemented.

The hermetically-sealed container 104 can create a contained volume of pressurized gas. The gas inside the hermetically-sealed container 104 can be pressurized to a desired operational level, which may be constant or vary over time. One or more lenses of the refractive system 102 can have a focus that changes based on pressure. A minor change in refractive index created by pressure for a given gas or liquid will have an effect on focal plane position in all wavebands. In some embodiments, adjusting the pressure of the hermetically-sealed container 104 may not involve physically moving parts, bending surfaces, or use of transparent liquids in the refractive system 102. The hermetically-sealed container 104 can have a volume pressurized to a level that is not at an ambient pressure level. In some embodiments, the hermetically-sealed container 104 can have one or more adjustable walls that can be moved to change the pressure by changing an internal volume of the hermetically-sealed container 104. In other embodiments, an external force may be applied to a flexible surface of the hermetically-sealed container 104 to change the pressure by changing an internal volume of the hermetically-sealed container 104.

The detector 106 can receive light passing through the refractive system 102, such as to generate images based on the received light or perform other functions based on the received light. The detector 106 can output images or other signals to one or more external system. In some embodiments, the detector 106 may also be configured to project light through the refractive system 102, such as to illuminate an external environment.

The pressure control 108 can adjust the pressure in the internal space of the hermetically-sealed container 104. The pressure of the internal volume of the container 104 can be changed in any suitable manner, such as by altering the internal volume of the container 104 and/or by altering the amount of gas within the container 104. In some embodiments, the pressure control 108 can be located externally to the container 104, and the container 104 may not need to contain any internal motor or other moving mechanical equipment. In some embodiments, the pressure control 108 could be an actuator that moves one or more surfaces of the container 104 or applies force to a flexible surface of the container 104 in order to adjust the internal volume of the container 104. The pressure control 108 could also or alternatively include a compressor and at least one valve that directly controls a pressure level inside the hermetically-sealed container 104.

Although FIGS. 1A through 2F illustrate one example of a lens cell 100 and examples of refractive systems 200-204, various changes may be made to FIGS. 1A through 2F. For example, various components in FIGS. 1A through 2F may be combined, further subdivided, replicated, omitted, or rearranged and additional components may be added according to particular needs. Also, the actual refractive system used in the lens cell 100 can vary widely based on the specific implementation.

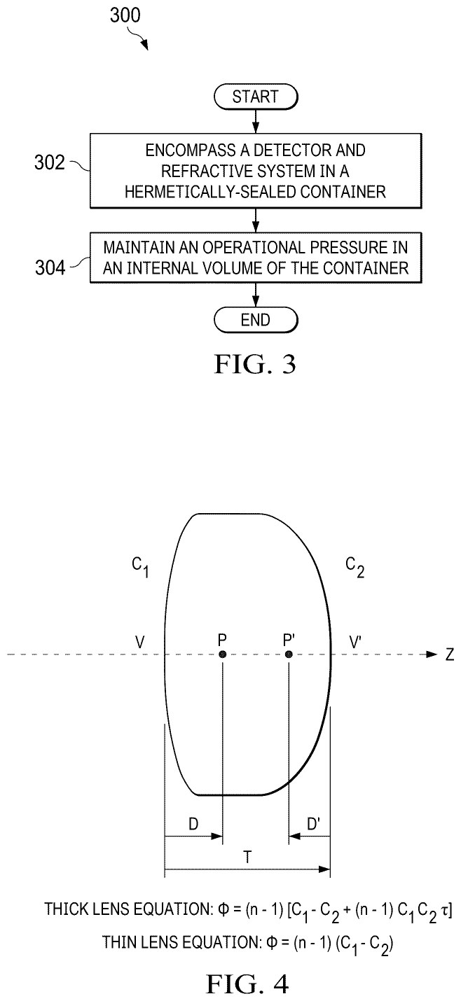

FIG. 3 illustrates an example method 300 for fine focus adjustment for a lens using pressure according to this disclosure. For case of explanation, the method 300 of FIG. 3 is described as being performed using the lens cell 100 of FIG. 1. However, the method 300 may be used with any other suitable system and any other suitable lens.

As shown in FIG. 3, a detector and a refractive system can be encompassed in a hermetically-sealed container at step 302. In some embodiments, the refractive system can include an imager at infinity focus, a relay imager, or a reimaging lens, which may include an imager and a relay imager.

Also, in some embodiments, the system can be optically athermal. Optically athermal describes an optical system that maintains a focus location on an object such as a detector. A system is optically athermal by the thermal expansion of lenses and housing, the lens materials change index over temperature, and the summation of those changes allows the focal position to remain on the detector or object. An operational pressure can be maintained in an internal volume of the container for focusing the refractive system at operating conditions at step 304. The operational pressure refers to a pressure for the internal volume when the lens cell 100 is under known conditions for an operation, which may be different from ambient conditions. Depending on the implementation, the operational pressure can be adjusted and set prior to operation, or the operational pressure can be adjustable during operation. The operational pressure of the internal volume of the container can be set to a non-ambient pressure, and the operational pressure of the internal volume of the container can be adjusted by a pressure control. In some embodiments, the pressure control can include an actuator configured to adjust a wall of the container and/or to apply a force to a flexible surface of the container in order to adjust the operational pressure of the internal volume. The pressure control may also or alternatively include a compressor configured to adjust the operational pressure of the internal volume and/or a valve configured to adjust the operational pressure of the internal volume.

Although FIG. 3 illustrates one example of a method 300 for fine adjustment for a lens using pressure, various changes may be made to FIG. 3. For example, while shown as a series of steps, various steps in FIG. 3 may overlap, occur in parallel, or occur any number of times.

FIG. 4 illustrates an example calculation for lens adjustment using pressure in accordance with this disclosure. As shown in FIG. 4, a lens can be pressurized to change a focal point, and all power of the lens is contained in the pressure cell. An outside surface can be flat or a window in order for C1 to go to 0. As a non-limiting example, the gas can be air. N3 can be fixed and the 1 value can be changed per n_air. An optical path length (OPL) of the pressure cell can change with n_air. A total change of a focal length can be based on change in effective focal length (ΔEFL) and change in OPL. The focal point can be determined by the following equations:

$$∅ = {∅}_{1} + {∅}_{2} - {∅}_{1} {∅}_{2} t \qquad ( 1 )$$

$$τ = \frac{t}{n} \qquad ( 2 )$$

$${∅}_{1} = ( n - 1 ) {C}_{1} \qquad ( 3 )$$

$${∅}_{2} = ( n - 1 ) {C}_{2} \qquad ( 4 )$$

$$∅ = ( n - 1 ) [ {C}_{1} - {C}_{2} + ( n - 1 ) {C}_{1} {C}_{2} τ ] \qquad ( 5 )$$

as t approaches 0:

$$∅ = ( n - 1 ) [ {C}_{1} - {C}_{2} ] , d = d ’ = 0 \qquad ( 6 )$$

where Ø represents power in diopters (m⁻¹), n represents an index of refraction, τ represents a reduced distance that is a ratio of the physical distance to the index of refraction, and C represents a curvature of a lens surface equal to 1/r where r is a radius of the lens surface. Examples of n for air and corresponding PSIA (absolute values) are shown below in Table 1.

| n_air | PSIA |
|---|---|
| (relative) | (absolute) |
| 1.000000 | 14.7 |
| 1.000018 | 15.7 |
| 1.000037 | 16.7 |
| 1.000055 | 17.7 |
| 1.000073 | 18.7 |
| 1.000092 | 19.7 |
| 1.000110 | 20.7 |
| 1.000128 | 21.7 |
| 1.000146 | 22.7 |
| 1.000165 | 23.7 |

Although FIG. 4 illustrates one example of a calculation for lens adjustment using pressure, various changes may be made to FIG. 4. For example, various components in FIG. 4 may be combined, further subdivided, replicated, omitted, or rearranged and additional components may be added according to particular needs. Also, the calculation for lens adjustment using pressure can vary widely based on the specific implementation.

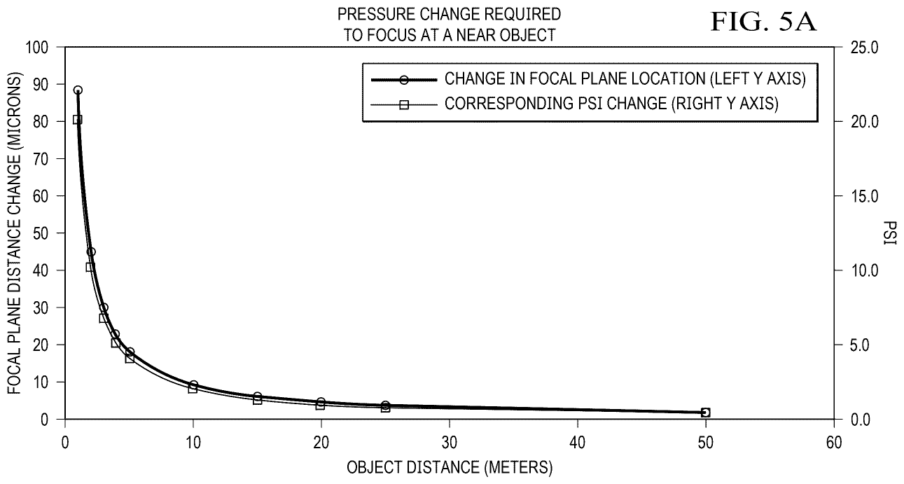

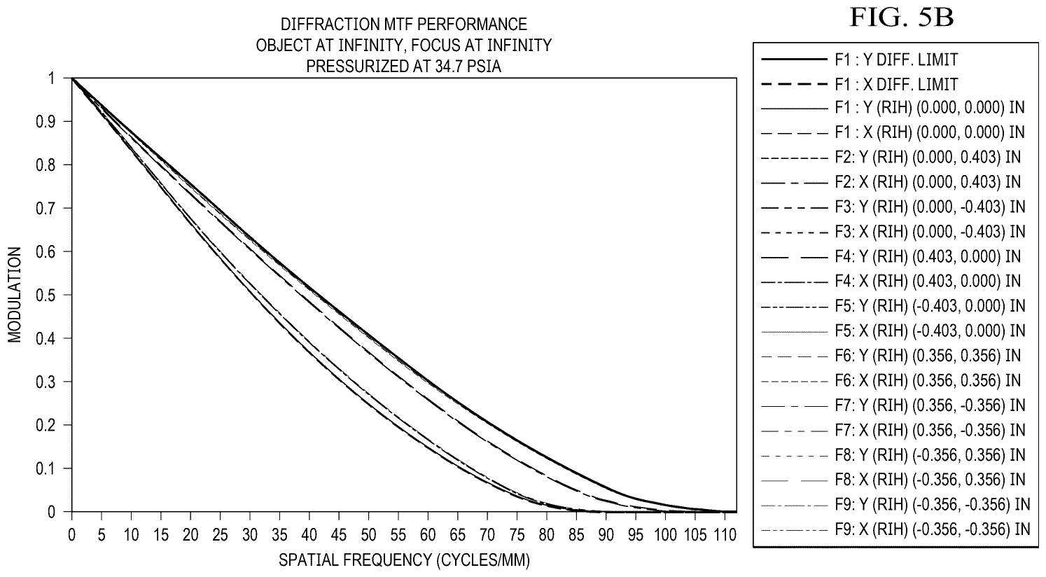

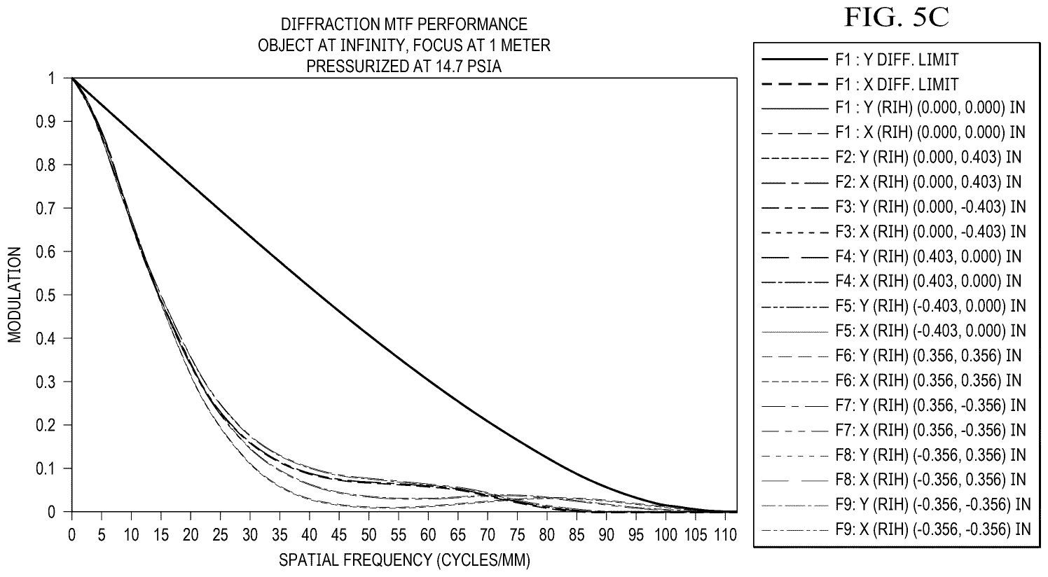

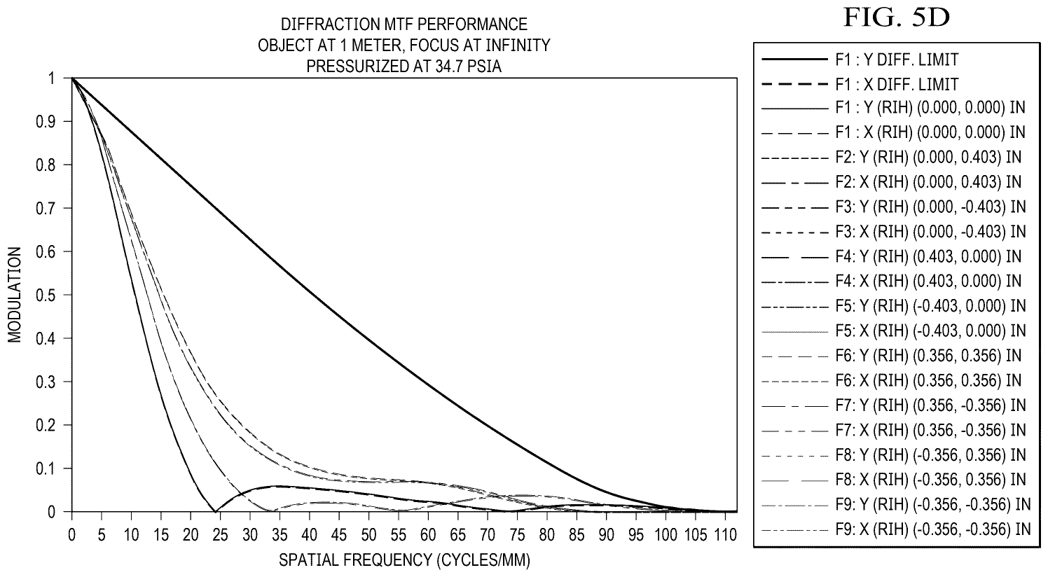

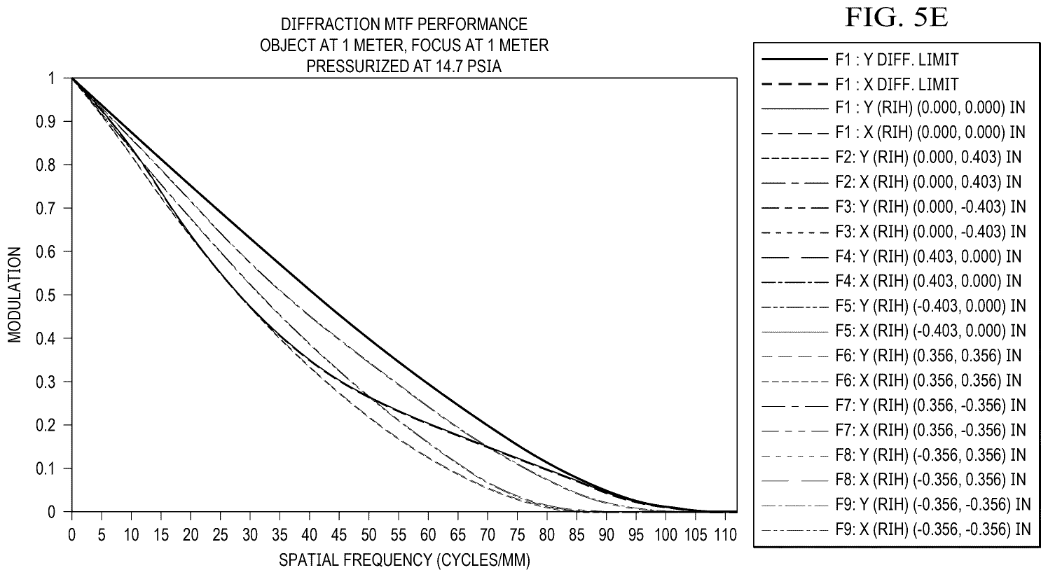

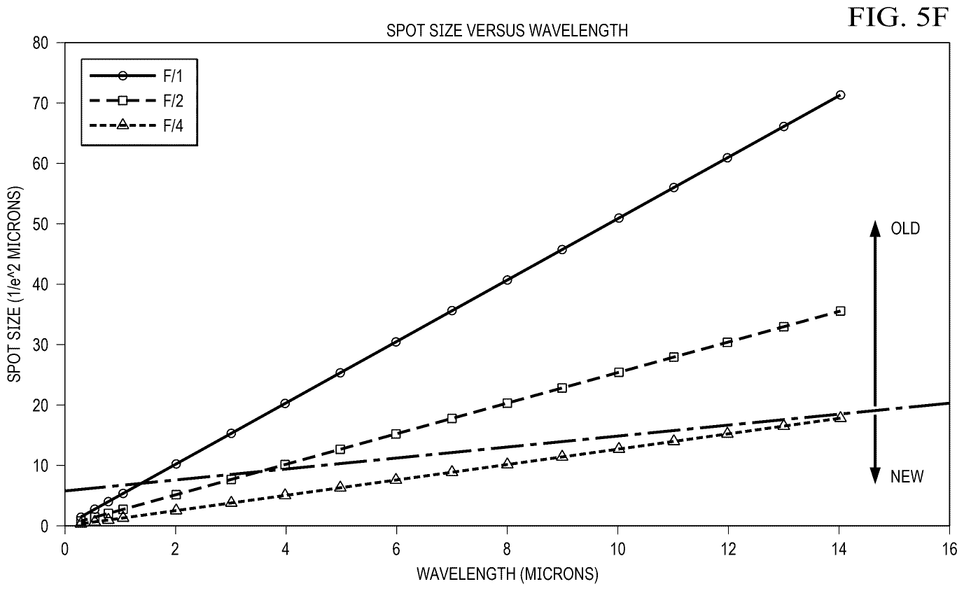

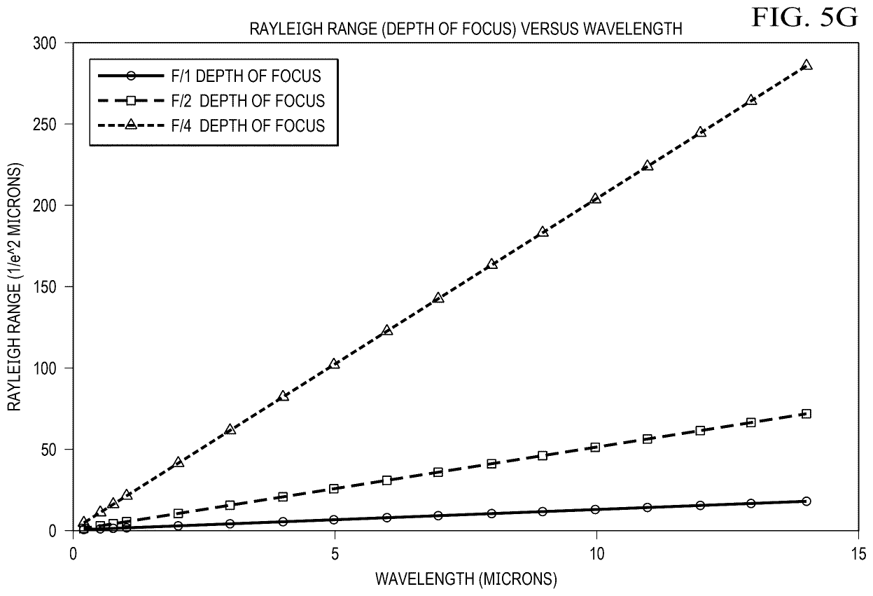

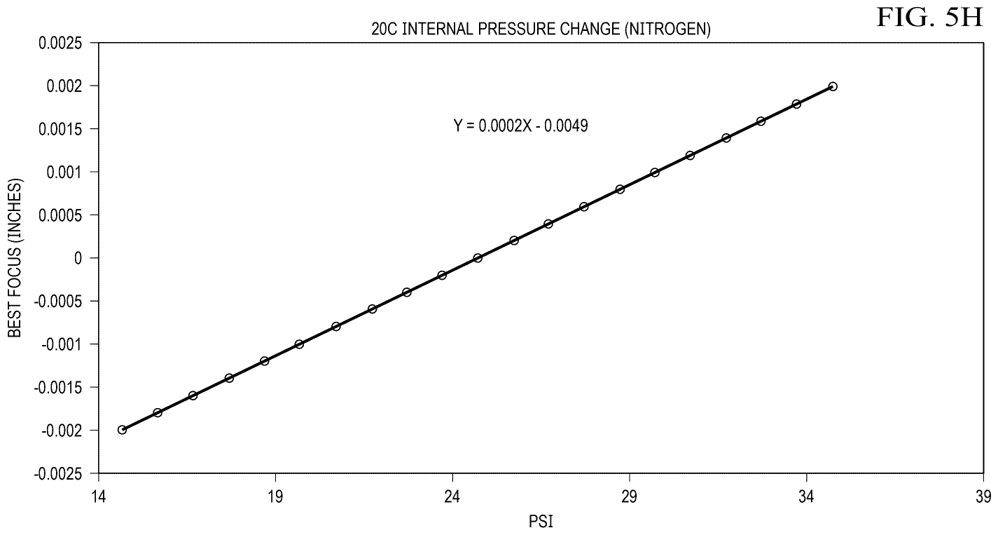

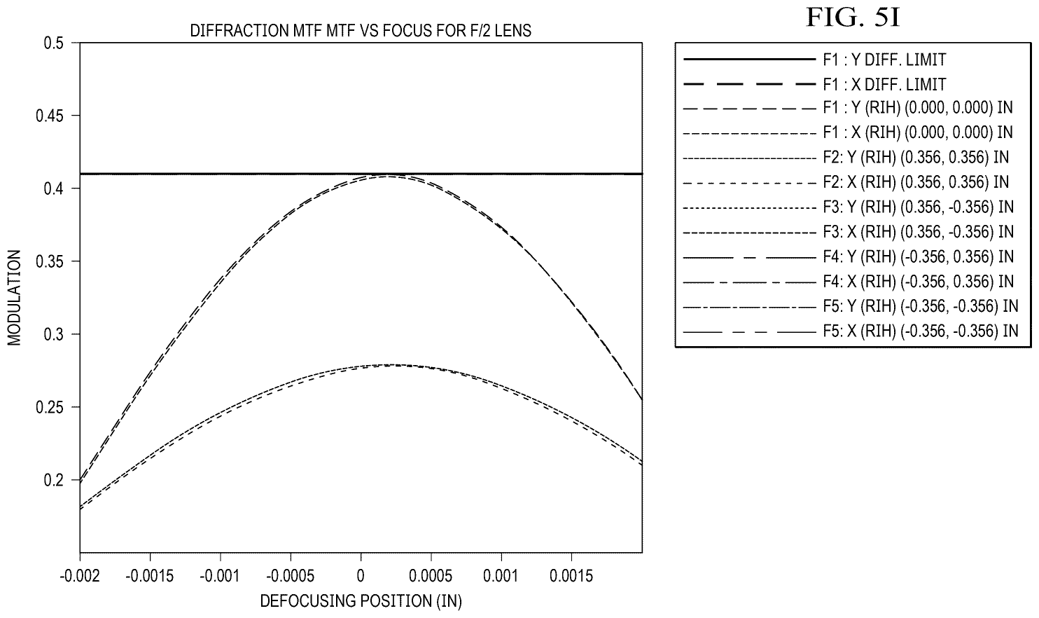

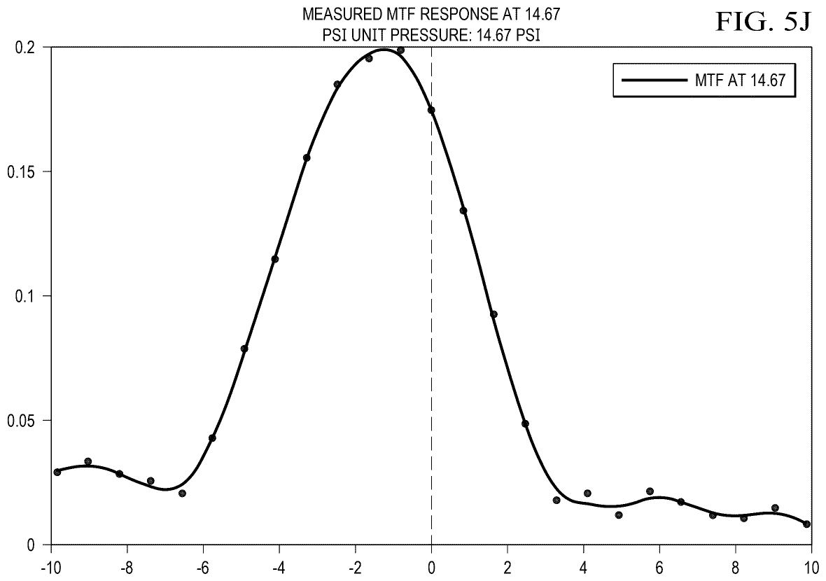

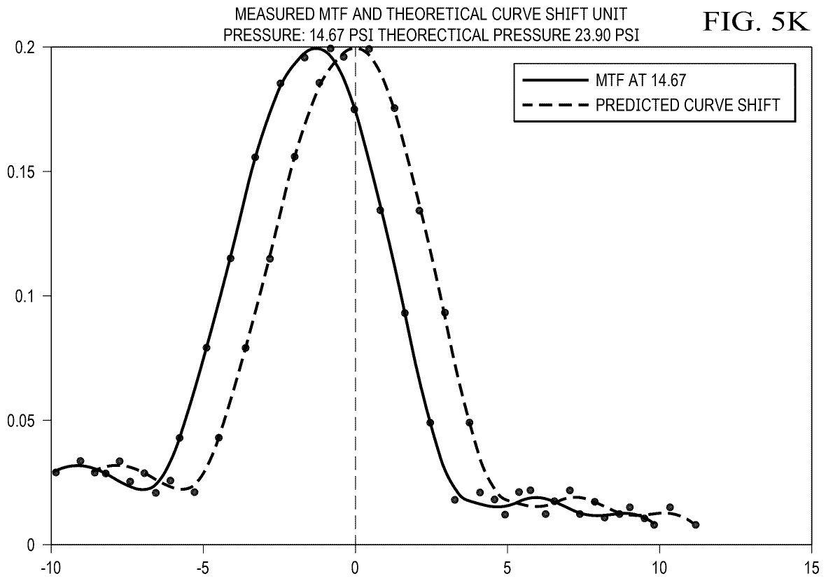

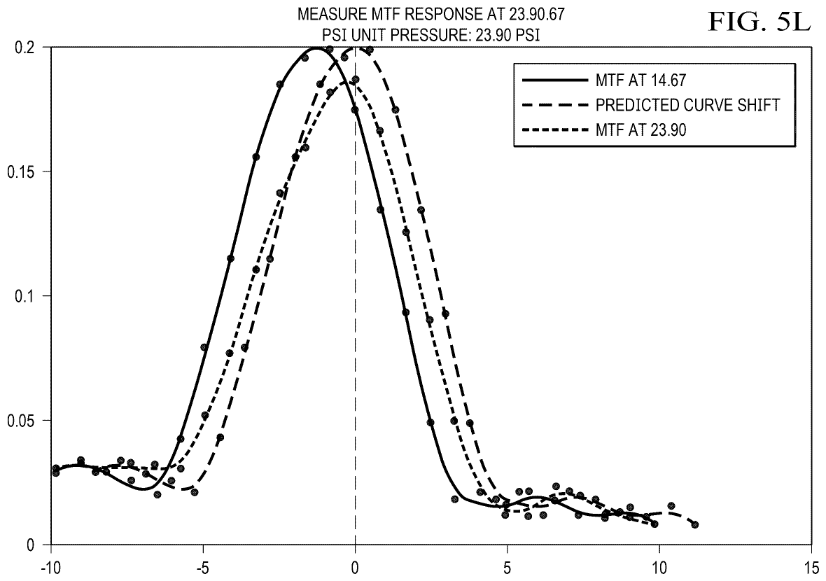

FIGS. 5A through 5L illustrate example results for fine focus adjustment for a lens using pressure in accordance with this disclosure. As shown in FIGS. 5A through 5G, an analysis of focus adjustment of the lens cell 100 using pressure was performed. As a non-limiting example, the lens cell 100, initially can be focused at an object 1 meter away, can be focus at infinity if a sensor is pressurized to 20 psi above mean sea level pressure (MSL). As another non-limiting example, the lens cell 100, initially focused at an object 2 meters away, can be focused at infinity if the sensor is pressurized to 10 psi above MSL.

As shown in FIGS. 5F and 5G, old systems are driven from F/4 towards F/1 as detectors improve and move to smaller pixels. Detectors can include visible detectors, mid-wave infrared (MWIR) detectors, and long-wave infrared (LWIR) sensors.

As shown in FIGS. 5H and 5I, environment in a lens design can be defined at a system level and often can be either fixed or uncontrolled. Gas and pressure environment in a lens cell can be varied to adjust a lens focus. This is due to a reduced pixel pitch detector and lens sealing technology. A lens cell can be focused at room temperature and pressure. The sensor can be pressurized to an operating pressure using a gas, such as nitrogen. A predetermined offset for shims can be added when focused at room temperature and pressure to account for unit pressurization.

As shown in FIGS. 5J through 5L, the X-axis units shown on the graphs are shim distances from focus. Determining a focus obtained using a target projector can be converted to a shim thickness. The Y-axis can be a modulation transfer function (MTF), for example, at 421 p/mm.

Although FIGS. 5A through 5L illustrate examples of results for fine focus adjustment for a lens using pressure, various changes may be made to FIGS. 5A through 5L. For example, various components in FIGS. 5A through 5L may be combined, further subdivided, replicated, omitted, or rearranged and additional components may be added according to particular needs.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a detector;
a refractive system configured to focus light on the detector; and
a hermetically-sealed container encompassing the detector and the refractive system and configured to maintain an operational pressure in an internal volume of the container for focusing the refractive system at operating conditions.

2. The apparatus of claim 1, wherein the operational pressure is not an ambient pressure.

3. The apparatus of claim 1, further comprising:
a pressure control configured to adjust the operational pressure in the internal volume of the container.

4. The apparatus of claim 3, wherein the pressure control includes an actuator configured to adjust a wall of the container in order to adjust the operational pressure of the internal volume.

5. The apparatus of claim 3, wherein the pressure control includes an actuator configured to apply a force to a flexible surface of the container in order to adjust the operational pressure of the internal volume.

6. The apparatus of claim 3, wherein the pressure control includes a compressor configured to adjust the operational pressure of the internal volume.

7. The apparatus of claim 3, wherein the pressure control includes a valve configured to adjust the operational pressure of the internal volume.

8. The apparatus of claim 1, wherein the refractive system includes an imager.

9. The apparatus of claim 1, wherein the refractive system includes a relay imager.

10. The apparatus of claim 1, wherein the sensor is passive optically athermal or passive optomechanically athermal over operational temperatures.

11. A method comprising:
encompassing a detector and a refractive system in a hermetically-sealed container; and
maintaining an operational pressure in an internal volume of the container for focusing the refractive system at operating conditions.

12. The method of claim 11, wherein the operational pressure is not an ambient pressure.

13. The method of claim 11, further comprising:
adjusting, using a pressure control, the operational pressure in the internal volume of the container.

14. The method of claim 13, wherein adjusting the operational pressure using the pressure control comprises adjusting, using an actuator, a wall of the container in order to adjust the operational pressure of the internal volume.

15. The method of claim 13, wherein adjusting the operational pressure using the pressure control comprises applying, using an actuator, a force to a flexible surface of the container in order to adjust the operational pressure of the internal volume.

16. The method of claim 13, wherein adjusting the operational pressure using the pressure control comprises adjusting, using a compressor, the operational pressure of the internal volume.

17. The method of claim 13, wherein adjusting the operational pressure using the pressure control comprises adjusting, using a valve, the operational pressure of the internal volume.

18. The method of claim 11, wherein the refractive system includes an imager.

19. The method of claim 11, wherein the refractive system includes a relay imager.

20. The method of claim 11, wherein the sensor is passive optically athermal or passive optomechanically athermal over operational temperatures.
